(19) United States
(12) Patent Application Publication
(10) Pub. No.: US 2024/0327754 A1
(43) Pub. Date: Oct. 3, 2024

(54) DETERGENT COMPOSITIONS

(71) Applicant: Conopco, Inc., d/b/a UNILEVER, Englewood Cliffs, NJ (US)

(72) Inventors: Neil Stephen BURNHAM, Liverpool (GB); David Stephen GRAINGER, Chester (GB); David Christopher THORLEY, Shavington (GB)

(73) Assignee: Conopco, Inc., d/b/a UNILEVER, Englewood Cliffs, NJ (US)

(21) Appl. No.: 18/700,435

(22) PCT Filed: Oct. 20, 2022
(86) PCT No.: PCT/EP2022/079229

§ 371 Date: Apr. 11, 2024

(30) Foreign Application Priority Data
Oct. 21, 2021 (EP) 21203922.6
Oct. 21, 2021 (EP) 21203927.5
Oct. 21, 2021 (EP) 21203931.7

(51) Int. Cl. C11D 1/29; C11D 3/00; C11D 3/37

(52) U.S. Cl. CPC C11D 1/29; C11D 3/0036; C11D 3/3715; C11D 3/3723

(57) ABSTRACT

The invention relates to a detergent composition comprising: from 0.5 to 50 wt. % of a C12-C14, alkyl ethoxylated sulfate surfactant; wherein the alkyl ethoxylated sulfate surfactant comprises a C14 alkyl group at a level of at least 50 wt. % of the alkyl ethoxylated sulfate surfactant; wherein the average degree of ethoxylation (EO) is from 2.5 to 3.5; wherein with reference to the wt. % of the total ethoxylated portion of said alkyl ethoxylated sulfate surfactant, the level of 1EO is from 10 to 25 wt. %, the level of 2EO is from 15 to 24 wt. %, the level of 3EO is from 20 to 35 wt. %, and the level of 4EO is from 12 to 25 wt. %; and, wherein the C12-C14 alkyl ethoxylated sulfate surfactant includes at most 10 wt. % alkyl chains of C15 and higher; the invention also relates to the use and method to enhance the foaming of a detergent composition by inclusion of said specified alkyl ethoxylated sulfate surfactant.

### FIELD OF THE INVENTION

The invention relates to the field of detergent compositions. The compositions are particularly useful for the washing of the items in the home, including dishes, cutlery and other cooking and eating utensils, for laundry of clothes and for the washing of the body including the hair. The compositions of the invention are particularly useful in the field of home care, for example in laundry compositions and hand dish wash compositions.

### BACKGROUND OF THE INVENTION

One common class of anionic surfactant used are Alkyl Ether Sulphates (AES). The generic structure for the sodium salt is:

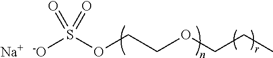

Where, on average n is ˜1-3 and n is 10-13.

In practice the materials used in laundry and dish wash products contain of a mixture of materials with a distribution of values for both n and r. A common commercial material is sodium C12/C14 3EO. While these materials provide reasonable amounts of foaming, such detergent compositions are desired to provide even greater levels of foam. The presence of large amounts of foam provides a pleasing sensorial aspect as well as a cue to the consumer to good cleaning efficacy. However, to deliver the required amount of foam the detergent composition needs to contain significant amounts of surfactant.

We have surprising found that by specifying an amount of the total of C14 material, and by specifying the distribution of the ethoxylated materials, then the foaming, as measured by foam volume, provided by this surfactant is enhanced. This leads to either greater levels of foaming, which are desirable for consumers, or the provision of the same level of foaming for less surfactant used.

### SUMMARY OF THE INVENTION

The invention relates in a first aspect to a detergent composition comprising:
from 0.5 to 50 wt. % of a C12-C14 alkyl ethoxylated sulfate surfactant;
wherein the alkyl ethoxylated sulfate surfactant comprises a C14 alkyl group at a level of at least 50 wt. % of the alkyl ethoxylated sulfate surfactant;
wherein the average degree of ethoxylation (EO) is from 2.5 to 3.5;
wherein with reference to the wt. % of the total ethoxylated portion of said alkyl ethoxylated sulfate surfactant, the level of 1EO is from 10 to 25 wt. %, the level of 2EO is from 15 to 24 wt. %, the level of 3EO is from 20 to 35 wt. %, and the level of 4EO is from 12 to 25 wt. %; and,
wherein the C12-C14 alkyl ethoxylated sulfate surfactant includes at most 10 wt. % alkyl chains of C15 and higher.

Preferably the alkyl ethoxylated sulfate surfactant comprises a C14 alkyl group at a level of at least 55 wt. %, preferably at least 60 wt. %, more preferably at least 65 wt. %, even more preferably at least 70 wt. %, even more preferably at least 75 wt. %, even more preferably at least 80 wt. %, even more preferably at least 85 wt. %, even more preferably at least 90 wt. %, even more preferably at least 95 wt. % of the alkyl ethoxylated sulfate surfactant.

Preferably the alkyl ethoxylated sulfate surfactant is present at a level of from 1 to 40 wt. %, preferably from 1.5 to 30 wt. %, more preferably from 2 to 25 wt. %, most preferably from 2.5 to 20 wt. %.

Preferably the average degree of ethoxylation (EO) of the alkyl ethoxylated sulfate surfactant is from 2.7 to 3.3.

Preferably with reference to the wt. % of the total ethoxylated portion of said alkyl ethoxylated sulfate surfactant, the level of 1EO is from 12 to 23 wt. %, preferably from 13 to 22 wt. %, more preferably from 14 to 21 wt. %, even more preferably from 15 to 20 wt. %.

Preferably with reference to the wt. % of the total ethoxylated portion of said alkyl ethoxylated sulfate surfactant, the level of 2EO is from 16 to 23 wt. %, preferably from 17 to 22 wt. %, more preferably from 18 to 22 wt. %.

Preferably with reference to the wt. % of the total ethoxylated portion of said alkyl ethoxylated sulfate surfactant, the level of 3EO is from 20 to 30 wt. %, preferably from 21 to 28 wt. %, more preferably from 22 to 26 wt. %.

Preferably with reference to the wt. % of the total ethoxylated portion of said alkyl ethoxylated sulfate surfactant, the level of 4EO is from 13 to 24 wt. %, preferably from 14 to 22 wt. %, more preferably from 15 to 21 wt. %.

Preferably the detergent composition additionally comprises from 1 to 40 wt. %, preferably from 2 to 30 wt. %, more preferably from 4 to 25 wt. %, most preferably from 5 to 20 wt. % of one or more other surfactants (other than the specified alkyl ethoxylated sulfate surfactant) selected from anionic surfactants, nonionic surfactants, cationic surfactants and amphoteric surfactants, preferably anionic surfactants, nonionic surfactants and amphoteric surfactants.

Preferably the detergent composition comprises from 0.5 to 15 wt. %, more preferably from 0.75 to 15 wt. %, even more preferably from 1 to 12 wt. %, most preferably from 1.5 to 10 wt. % of cleaning boosters selected from antiredeposition polymers, soil release polymers, alkoxylated polycarboxylic acid esters and mixtures thereof, more preferably selected from antiredeposition polymers, and soil release polymers.

Preferably the antiredeposition polymers are alkoxylated polyamines; and/or wherein the soil release polymer is a polyester soil release polymer.

Preferably the detergent composition is a composition selected from: powder detergent compositions, liquid detergent compositions, gel detergent compositions.

In a second aspect, the invention relates to the use of a C12-C14 alkyl ethoxylated sulfate surfactant to enhance the foaming of a detergent composition;
wherein the alkyl ethoxylated sulfate surfactant comprises a C14 alkyl group at a level of at least 50 wt. % of the alkyl ethoxylated sulfate surfactant;
wherein the average degree of ethoxylation (EO) is from 2.5 to 3.5; and,
wherein with reference to the wt. % of the total ethoxylated portion of said alkyl ethoxylated sulfate surfactant, the level of 1EO is from 10 to 25 wt. %, the level of 2EO is from 15 to 24 wt. %, the level of 3EO is from 20 to 35 wt. %, and the level of 4EO is from 12 to 25 wt. %; and,
wherein the C12-C14 alkyl ethoxylated sulfate surfactant includes at most 10 wt. % alkyl chains of C15 and higher.

In a third aspect, the invention relates to a method to enhance the foaming of a detergent composition, wherein said method involves inclusion of from 0.5 to 50 wt. % of a C12-C14 alkyl ethoxylated sulfate surfactant;
wherein the alkyl ethoxylated sulfate surfactant comprises a C14 alkyl group at a level of at least 50 wt. % of the alkyl ethoxylated sulfate surfactant;
wherein the average degree of ethoxylation (EO) is from 2.5 to 3.5;
wherein with reference to the wt. % of the total ethoxylated portion of said alkyl ethoxylated sulfate surfactant, the level of 1EO is from 10 to 25 wt. %, the level of 2EO is from 15 to 24 wt. %, the level of 3EO is from 20 to 35 wt. %, and the level of 4EO is from 12 to 25 wt. %; and,
wherein the C12-C14 alkyl ethoxylated sulfate surfactant includes at most 10 wt. % alkyl chains of C15 and higher.

Preferably the enhancement of the foaming involves enhancing the foam volume, more preferably an increase in foam volume.

### DETAILED DESCRIPTION OF THE INVENTION

### Alkyl Ethoxylated Sulfate Surfactant

The detergent composition comprises from 0.5 to 50 wt. % of a C12-C14 alkyl ethoxylated sulfate surfactant;
wherein the alkyl ethoxylated sulfate surfactant comprises a C14 alkyl group at a level of at least 50 wt. % of the alkyl ethoxylated sulfate surfactant;
wherein the average degree of ethoxylation (EO) is from 2.5 to 3.5;
wherein with reference to the wt. % of the total ethoxylated portion of said alkyl ethoxylated sulfate surfactant, the level of 1EO is from 10 to 25 wt. %, the level of 2EO is from 15 to 24 wt. %, the level of 3EO is from 20 to 35 wt. %, and the level of 4EO is from 12 to 25 wt. %; and,
wherein the C12-C14 alkyl ethoxylated sulfate surfactant includes at most 10 wt. % alkyl chains of C15 and higher (e.g. C16, C18, C20, C22 etc.).

The C12-C14 alkyl ethoxylated sulfate surfactant includes at most 10 wt. %, more preferably 8 wt. %, even more preferably 6 wt. %, even more preferably 5 wt. %, even more preferably 4 wt. %, even more preferably 3 wt. %, even more preferably 2 wt. %, most preferably 1 wt. % alkyl chains of C15 and higher. Even more preferably the C12-C14 material is free from alkyl chains of C15 and higher (e.g. C16, C18, C20, C22 etc.).

Preferably the C12-C14 alkyl ethoxylated sulfate surfactant comprises 90 to 100 wt. %, preferably from 91 to 100 wt. %, more preferably from 92 to 100 wt. %, more preferably from 93 to 100 wt. %, more preferably from 94 to 100 wt. %, more preferably from 95 to 100 wt. %, more preferably from 96 to 100 wt. %, more preferably from 97 to 100 wt. %, more preferably from 98 to 100 wt. %, more preferably from 99 to 100 wt. % of C12 and C14 alkyl chains.

The claimed alkyl ethoxylated sulfate surfactant is present at a level of from 0.5 to 50 wt. %, preferably from 1 to 40 wt. %, more preferably from 1.5 to 30 wt. %, even more preferably from 2 to 25 wt. %, most preferably from 2.5 to 20 wt. %.

The claimed alkyl ethoxylated sulfate surfactant has an average degree of ethoxylation (EO) of from 2.5 to 3.5, preferably from 2.7 to 3.3.

The average degree of ethoxylation of the alkyl ethoxylated sulfate surfactant of from 2.5 to 3.5, preferably from 2.7 to 3.3. This average value is calculated based on the levels of all of the different ethoxylated material (1EO, 2EO, 3EO, 4EO, 5EO etc. . . . ) present on the surfactant. To be clear, the level of 0EO surfactant (the non-ethoxylated portion of the surfactant) is not included in the calculation of the average degree of ethoxylation.

It is understood that it is common that there is a non-ethoxylated portion of alkyl sulfate surfactant also present in these surfactant mixtures. For example, after the ethoxylation process, the resulting material is a mixture of 0EO, 1EO, 2EO, 3EO, 4EO, 5EO etc . . . materials. It is a mixture of ethoxylated material of various EO, with some non-ethoxylated material.

It is preferred that the wt. % level of non-ethoxylated material in the alkyl ethoxylated sulfate surfactant is from 8 to 27 wt. %, preferably from 10 to 25 wt. %, more preferably from 12 to 22 wt. %. This is calculated based on the wt. % level of non-ethoxylated material with reference to the total amount of alkyl ethoxylated sulfate surfactant.

This preferred level of 0EO material (non-ethoxylated material) in the alkyl ethoxylated sulfate surfactant is different to the levels of 0EO seen in common commercial materials. For example, a common commercial C12-C14 3EO SLES was measured and had a level of 0EO being ˜37 wt. % of the total surfactant.

Preferably the alkyl ethoxylated sulfate surfactant comprises a C14 alkyl group at a level of at least 55 wt. %, preferably at least 60 wt. %, more preferably at least 65 wt. %, even more preferably at least 70 wt. %, even more preferably at least 75 wt. %, even more preferably at least 80 wt. %, even more preferably at least 85 wt. %, even more preferably at least 90 wt. %, even more preferably at least 95 wt. % of the alkyl ethoxylated sulfate surfactant. The surfactant may even be composed of C14 alkyl group (i.e., be 100 wt. % C14 alkyl).

While the alkyl group of the alkyl ethoxylated sulfate surfactant may be linear or branched, preferably the alkyl group of alkyl ethoxylated sulfate surfactant is linear.

Preferably with reference to the wt. % of the total ethoxylated portion of said alkyl ethoxylated sulfate surfactant, the level of 1EO is from 12 to 23 wt. %, preferably from 13 to 22 wt. %, more preferably from 14 to 21 wt. %, even more preferably from 15 to 20 wt. %.

Preferably with reference to the wt. % of the total ethoxylated portion of said alkyl ethoxylated sulfate surfactant, the level of 2EO is from 16 to 23 wt. %, preferably from 17 to 22 wt. %, more preferably from 18 to 22 wt. %.

Preferably with reference to the wt. % of the total ethoxylated portion of said alkyl ethoxylated sulfate surfactant, the level of 3EO is from 20 to 30 wt. %, preferably from 21 to 28 wt. %, more preferably from 22 to 26 wt. %.

Preferably with reference to the wt. % of the total ethoxylated portion of said alkyl ethoxylated sulfate surfactant, the level of 4EO is from 13 to 24 wt. %, preferably from 14 to 22 wt. %, more preferably from 15 to 21 wt. %.

These preferred features (the wt. % levels of 1EO, 2EO, 3EO and 4EO with reference to the total wt. % of the ethoxylated portion of the alkyl ethoxylated sulfate surfactant) are calculated on the basis of the total level of only the ethoxylated material contained in the surfactant, not including the wt. % portion of the non-ethoxylated material of the surfactant.

For example, the calculation for the level of 1EO would be as follows:

Wt. % of 1EO surfactant÷(total wt. % of all ethoxylated portions of the surfactant)

It is understood that it is common that there is a non-ethoxylated portion of alkyl sulfate surfactant also present. This material is not included in the above calculations for the preferred levels of 1EO, 2EO, 3EO and 4EO.

### Methods of Ethoxylation

Ethoxylation reactions are described in Non-Ionic Surfactant Organic Chemistry (N. M. van Os ed), Surfactant Science Series Volume 72, CRC Press.

Preferably the ethoxylation reactions are base catalysed using NaOH, KOH, or NaOCH₃. Even more preferred are catalyst which provide narrower ethoxy distribution than NaOH, KOH, or NaOCH₃. Preferably these narrower distribution catalysts involve a Group II base such as Ba dodecanoate; Group II metal alkoxides; Group II hyrodrotalcite as described in WO 2007/147866. Lanthanides may also be used.

### Specific Methods of Narrow Range Ethoxylation

Narrow range ethoxylation catalyst are described in EP3289790 (Procter & Gamble), EP1747183 (Hacros); Santacesatia et al Ind. Eng. Chem. Res. 1992, 31, 2419-2421; U.S. Pat. No. 4,239,917 (Conoco); Li et al ACS Omega. 2021 Nov. 9; 6 (44): 29774-29780; Hreczuch et al J. Am. Oil Chem. Soc. 1996, 73, 73-78. Catalysts based on Ca or Ba are preferred, most preferably in combination with sulfuric acid.

### General Example Method

A calcium catalyst was prepared according to EP1747183, with the following composition: n-Butanol 73.5 wt. %, calcium hydroxide 15.2 wt. %, 2-ethylhexanoic acid, and 3.5 wt. %, conc. sulfuric acid 7.8 wt. %.

To prepare the catalyst, a three-neck round bottom flask is equipped with a magnetic stir bar, a glass stopper, a Dean-Stark trap filled with n-butanol, a condenser topped with a calcium chloride drying tube, and is placed in an oil bath. The n-butanol is charged to the flask and, stirring is initiated. The calcium hydroxide is slowly added, and allowed to stir for 15 minutes. A carboxylic acid (such as 2-ethylhexanoic acid) is then added to the mixture via syringe. The flask containing the mixture is then heated to above 120 degrees centigrade at atmospheric pressure. The stirring suspension is allowed to reflux for up to about 8 hours. Under these conditions, water and the dispersing medium will be removed during the process, but the dispersing medium is recycled into the reaction vessel. After cooling to room temperature, the stir bar is removed, and an overhead stirrer is added. The Dean-Stark trap, condenser, drying tube, oil bath, and stoppers are removed. A source of nitrogen, thermometer, water bath, and pressure equalizing dropping funnel are added. The pressure equalizing dropping funnel is charged with an inorganic acid (such as sulfuric acid), and the acid is added over the course of about 3 hours. The internal temperature is maintained at or below about 25 degrees centigrade by the use of a water bath and ice. After the acid is added completely, the suspension is allowed to stir for an additional 30-60 minutes at a temperature of about 25° C.

This catalyst was used to produce narrow range ethoxylates as follows: −915 g of a C12-C14 alcohol (C12=10 wt. %, C14=89 wt. % C16=1 wt. %) was charged into a 2 gallon stainless steel autoclave equipped with an overhead stirrer, internal steam heating, water cooling, and thermocouple. The C12-C14 alcohol was vacuum dried at 90° C., then 2.1 g of catalyst was added and vacuum stripped at 90° C. until all the solvent was removed (˜ 5 minutes). The reactor was heated to 140° C. and ethylene oxide slowly added. After an induction period a small exothermic reaction is observed on which the addition of ethylene oxide is continued at a pressure of 2 bar, until 3 moles of ethylene oxide in total had been consumed. Temperature was controlled using water cooling and allowed to reach 180° C. When a mole ratio of 3:1 ethylene oxide to C12-C14 alcohol had reacted to form alcohol ethoxylate the temperature was lowered to 90° C. and the product vacuumed stripped for 3 hours.

The ethoxylation procedure was repeated using a (C₁₁H₂₃COO)₂Ba described in Ind. Eng. Chem. Res. 1992, 31, 2419-2421 and a barium oxide/sulfuric acid catalyst as described in WO2012028435 (Kolb).

### Sulfation

The alcohol/ethoxylate mixtures may be sulfated by any of the known methods for sulfating such materials (cf. J. Falbe (ed.), “Surfactants in Consumer Products”, Springer Verlag, Berlin-Heidelberg, 1987, page 61), preferably using reactors operating on the falling-film principle.

Suitable sulfonating agents are chlorosulfonic acid and, in particular, gaseous sulfur trioxide. The sulfur trioxide is normally diluted with an inert gas, preferably air or nitrogen, and used in the form of a gas mixture containing the sulfonating agent in a concentration of 1 to 8% by volume and, more particularly, 2 to 5% by volume.

The molar ratio of alcohol/ethoxylate mixture to sulfating agent is normally from 1:0.95 to 1:1.3 and is preferably from 1:1 to 1:1.05. The sulfation reaction is normally carried out at temperatures of from 25° to 70° C.

A further reference for the general method for sulfation is Anionic Surfactants Organic Chemistry, Surfactant Science Series 56, Edited by H. W. Stache (Marcel Dekker 1996).

Preferably ether sulfate is produced using SO₃ for the sulfation, preferably in a multitube falling film reactor and that dioxane are reduced to less than 20 ppm, more preferably less than 10 ppm, most preferably less than 5 ppm on a 100% active basis. Methods to reduce dioxane are described in WO2017/179026 (Ballestra) and WO2014/058791 (Chemithon).

### Detergent Composition

Preferably the detergent composition is a composition selected from: powder detergent compositions, liquid detergent compositions, gel detergent compositions.

It may be preferred that the composition is a non-liquid detergent composition, preferably a non-aqueous liquid detergent composition.

The alkyl ethoxylated sulfate surfactant of the invention can be incorporated into powder detergent compositions, liquid detergent compositions or gel detergent compositions using known processes common in the field for the corresponding commercial alkyl ether sulfate material.

### Additional Preferred Ingredients

### Surfactants

Preferably the detergent composition additionally comprises from 1 to 40 wt. %, preferably from 2 to 30 wt. %, more preferably from 4 to 25 wt. %, most preferably from 5 to 20 wt. % of one or more other surfactants (other than the specified alkyl ethoxylated sulfate surfactant) selected from anionic surfactants, nonionic surfactants, cationic surfactants and amphoteric surfactants, preferably anionic surfactants, nonionic surfactants and amphoteric surfactants.

Preferably the additional anionic surfactant is preferably selected from primary alkyl sulfates, linear alkyl benzene sulfonates, internal olefin sulfonates, alpha olefin sulfonates, soaps, anionically modified APGs, furan based anionics, and citrems, tatems and datems, more preferably selected from primary alkyl sulfates, linear alkyl benzene sulfonates, and furan based anionics. Most preferred additional anionic surfactants are linear alkyl benzene sulfonates.

Preferably the nonionic surfactant is selected from alcohol alkoxylates (preferably alcohol ethoxylates), alkyl polyglucosides, alkyl polypentosides. Most preferred nonionic surfactants are preferably selected from alcohol ethoxylates having from C12-C15 with a mole average of from 5 to 9 ethoxylates and/or alcohol ethoxylates having from C16-C18 with a mole average of from 5 to 14 ethoxylates.

Preferred amphoteric surfactants include coco amidopropyl betaine (CAPB).

### Further Ingredients

The formulation may contain further ingredients.

### Builders or Complexing Agents

The detergent formulation in the form of a non-liquid, preferably powder, preferably comprises a builder or a complexing agent. This may be present at levels of from 5 to 75 wt. %, preferably from 8 to 65 wt. %, more preferably from 10 to 60 wt. % of the detergent composition.

Such materials may include: calcium sequestrant materials; precipitating materials; calcium ion-exchange materials; and mixtures thereof.

Preferred examples of such materials include carbonates, layered silicates, polycarboxylates (e.g. EDTA, NTA), citrates (e.g. trisodium citrate), silicates (e.g. sodium silicate) and zeolites.

Preferred builders or complexing agents are carbonates, for example sodium carbonate.

The detergent formulation in the form of a non-liquid, preferably powder, preferably comprises less than 20 wt. %, more preferably less than 15 wt. %, most preferably less than 10 wt. % of zeolite (an aluminosilicate material).

Most preferably the detergent formulation comprises less than 1 wt. % of phosphate.

The detergent formulation in the form of a non-liquid, preferably powder can preferably be not built i.e., contain less than 1 wt. % of builder.

If the detergent composition is an aqueous liquid laundry detergent it is preferred that mono propylene glycol or glycerol is present at a level from 1 to 30 wt. %, most preferably 2 to 18 wt. %.

### Cleaning Boosters

The detergent composition comprises from 0.5 to 15 wt. %, more preferably from 0.75 to 15 wt. %, even more preferably from 1 to 12 wt. %, most preferably from 1.5 to 10 wt. % of cleaning boosters selected from antiredeposition polymers; soil release polymers; alkoxylated polycarboxylic acid esters (for example as described in WO/2019/008036 and WO/2019/007636); and mixtures thereof.

### Antiredeposition Polymers

Preferred antiredeposition polymers include alkoxylated polyamines.

A preferred alkoxylated polyamine comprises an alkoxylated polyethylenimine, and/or alkoxylated polypropylenimine. The polyamine may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25. A preferred material is ethoxylated polyethyleneimine, with an average degree of ethoxylation being from 10 to 30 preferably from 15 to 25, where a nitrogen atom is ethoxylated.

### Soil Release Polymer

Preferably the soil release polymer is a polyester soil release polymer.

Preferred soil release polymers include those described in WO 2014/029479 and WO 2016/005338.

Preferably the polyester based soil release polymer is a polyester according to the following formula (I)

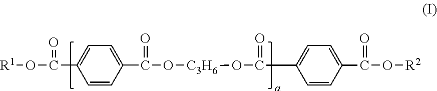

wherein
R¹ and R² independently of one another are X—(OC₂H₄)ₙ—(OC₃H₆)ₘ wherein X is C₁₋₄ alkyl and preferably methyl, the —(OC₂H₄) groups and the —(OCH₆) groups are arranged blockwise and the block consisting of the —(OCH₆) groups is bound to a COO group or are HO—(C₃H₆), and preferably are independently of one another X—(OC₂H₄)ₙ—(OC₃H₆)ₘ,
n is based on a molar average number of from 12 to 120 and preferably of from 40 to 50,
m is based on a molar average number of from 1 to 10 and preferably of from 1 to 7, and
a is based on a molar average number of from 4 to 9.

Preferably the polyester provided as an active blend comprising:
A) from 45 to 55% by weight of the active blend of one or more polyesters according to the following formula (I)

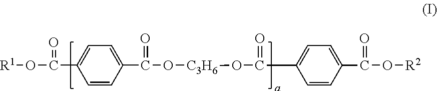

wherein
R¹ and R² independently of one another are X—(OC₂H₄)ₙ—(OC₃H₆)ₘ wherein X is C₁₋₄ alkyl and preferably methyl, the —(OC₂H₄) groups and the —(OCH₆) groups are arranged blockwise and the block consisting of the —(OC₃H₆) groups is bound to a COO group or are HO—(C₃H₆), and preferably are independently of one another X—(OC₂H₄)ₙ—(OC₃H₆)ₘ,
n is based on a molar average number of from 12 to 120 and preferably of from 40 to 50,
m is based on a molar average number of from 1 to 10 and preferably of from 1 to 7, and
a is based on a molar average number of from 4 to 9 and
B) from 10 to 30% by weight of the active blend of one or more alcohols selected from the group consisting of ethylene glycol, 1,2-propylene glycol, 1,3-propylene glycol, 1,2-butylene glycol, 1,3-butylene glycol, 1,4-butylene glycol and butyl glycol and
C) from 24 to 42% by weight of the active blend of water.

### Alkoxylated Polycarboxylic Acid Esters

Alkoxylated polycarboxylic acid esters are obtainable by first reacting an aromatic polycarboxylic acid containing at least three carboxylic acid units or anhydrides derived therefrom, preferably an aromatic polycarboxylic acid containing three or four carboxylic acid units or anhydrides derived therefrom, more preferably an aromatic polycarboxylic acid containing three carboxylic acid units or anhydrides derived therefrom, even more preferably trimellitic acid or trimellitic acid anhydride, most preferably trimellitic acid anhydride, with an alcohol alkoxylate and in a second step reacting the resulting product with an alcohol or a mixture of alcohols, preferably with C16/C18 alcohol.

### Fluorescent Agent

The composition preferably comprises a fluorescent agent (optical brightener).

Fluorescent agents are well known and many such fluorescent agents are available commercially. Usually, these fluorescent agents are supplied and used in the form of their alkali metal salts, for example, the sodium salts.

The total amount of the fluorescent agent or agents used in the composition is generally from 0.0001 to 0.5 wt. %, preferably 0.005 to 2 wt. %, more preferably 0.01 to 0.1 wt. %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN.

Preferred fluorescers are fluorescers with CAS-No 3426-43-5; CAS-No 35632-99-6; CAS-No 24565-13-7; CAS-No 12224-16-7; CAS-No 13863-31-5; CAS-No 4193-55-9; CAS-No 16090 02-1; CAS-No 133-66-4; CAS-No 68444-86-0; CAS-No 27344-41-8.

Most preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulphonate, disodium 4,4′-bis{[(4-anilino-6-morpholino-1,3,5-triazin-2-yl)]amino}stilbene-2-2′ disulphonate, and disodium 4,4′-bis(2-sulphostyryl) biphenyl.

### Shading Dye

It is advantageous to have shading dye present in the formulation.

Dyes are described in Color Chemistry Synthesis, Properties and Applications of Organic Dyes and Pigments, (H Zollinger, Wiley VCH, Zürich, 2003) and, Industrial Dyes Chemistry, Properties Applications. (K Hunger (ed), Wiley-VCH Weinheim 2003).

Dyes for use in laundry detergents preferably have an extinction coefficient at the maximum absorption in the visible range (400 to 700 nm) of greater than 5000 L mol⁻¹ cm⁻¹, preferably greater than 10000 L mol⁻¹ cm⁻¹.

Preferred dye chromophores are azo, azine, anthraquinone, phthalocyanine and triphenylmethane. Azo, anthraquinone, phthalocyanine and triphenylmethane dyes preferably carry a net anionic charged or are uncharged. Azine dyes preferably carry a net anionic or cationic charge.

Blue or violet Shading dyes are most preferred. Shading dyes deposit to fabric during the wash or rinse step of the washing process providing a visible hue to the fabric. In this regard the dye gives a blue or violet colour to a white cloth with a hue angle of 240 to 345, more preferably 260 to 320, most preferably 270 to 300. The white cloth used in this test is bleached non-mercerised woven cotton sheeting.

Shading dyes are discussed in WO 2005/003274, WO 2006/032327 (Unilever), WO 2006/032397 (Unilever), WO 2006/045275 (Unilever), WO 2006/027086 (Unilever), WO 2008/017570 (Unilever), WO 2008/141880 (Unilever), WO 2009/132870 (Unilever), WO 2009/141173 (Unilever), WO 2010/099997 (Unilever), WO 2010/102861 (Unilever), WO 2010/148624 (Unilever), WO 2008/087497 (P&G), WO 2011/011799 (P&G), WO 2012/054820 (P&G), WO 2013/142495 (P&G), WO 2013/151970 (P&G), WO 2018/085311 (P&G) and WO 2019/075149 (P&G).

A mixture of shading dyes may be used.

The shading dye chromophore is most preferably selected from mono-azo, bis-azo and azine.

Mono-azo dyes preferably contain a heterocyclic ring and are most preferably thiophene dyes. The mono-azo dyes are preferably alkoxylated and are preferably uncharged or anionically charged at pH=7. Alkoxylated thiophene dyes are discussed in WO2013/142495 and WO2008/087497. A preferred example of a thiophene dye is shown below:

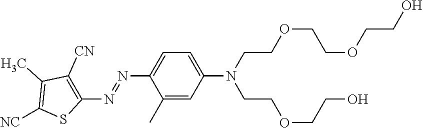 [SMILES: Cc1cc(N(CCOCCO)CCOCCOCCO)ccc1/N=N/c1sc(C#N)c(C)c1C#N]

Bis-azo dyes are preferably sulphonated bis-azo dyes. Preferred examples of sulphonated bis-azo compounds are direct violet 7, direct violet 9, direct violet 11, direct violet 26, direct violet 31, direct violet 35, direct violet 40, direct violet 41, direct violet 51, direct violet 66, direct violet 99 and alkoxylated versions thereof.

Alkoxylated bis-azo dyes are discussed in WO2012/054058 and WO/2010/151906.

An example of an alkoxylated bis-azo dye is:

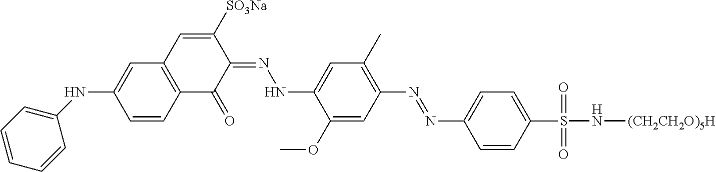

Azine dyes are preferably selected from sulphonated phenazine dyes and cationic phenazine dyes. Preferred examples are acid blue 98, acid violet 50, dye with CAS-No 72749-80-5, acid blue 59, and the phenazine dye selected from:

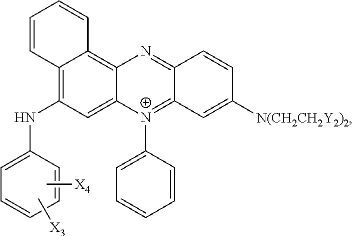

wherein:
X₃ is selected from: —H; —F; —CH₃; —C₂H₅; —OCH₃; and, —OC₂H₅;
X₄ is selected from: —H; —CH₃; —C₂H₅; —OCH₃; and, —OC₂H₅;
Y₂ is selected from: —OH; —OCH₂CH₂OH; —CH(OH) CH₂OH; —OC(O) CH₃; and, C(O)OCH₃.

Anthraquinone dyes covalently bound to ethoxylate or propoxylated polyethylene imine may be used as described in WO2011/047987 and WO 2012/119859.

The shading dye is preferably present is present in the composition in range from 0.0001 to 0.1 wt %. Depending upon the nature of the shading dye there are preferred ranges depending upon the efficacy of the shading dye which is dependent on class and particular efficacy within any particular class. As stated above the shading dye is preferably a blue or violet shading dye.

### Perfume

The composition preferably comprises a perfume. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

Preferably the perfume comprises at least one note (compound) from: alpha-isomethyl ionone, benzyl salicylate; citronellol; coumarin; hexyl cinnamal; linalool; pentanoic acid, 2-methyl-, ethyl ester; octanal; benzyl acetate; 1,6-octadien-3-ol, 3,7-dimethyl-, 3-acetate; cyclohexanol, 2-(1,1-dimethylethyl)-, 1-acetate; delta-damascone; beta-ionone; verdyl acetate; dodecanal; hexyl cinnamic aldehyde; cyclopentadecanolide; benzeneacetic acid, 2-phenylethyl ester; amyl salicylate; beta-caryophyllene; ethyl undecylenate; geranyl anthranilate; alpha-irone; beta-phenyl ethyl benzoate; alpa-santalol; cedrol; cedryl acetate; cedry formate; cyclohexyl salicyate; gamma-dodecalactone; and, beta phenylethyl phenyl acetate.

Useful components of the perfume include materials of both natural and synthetic origin. They include single compounds and mixtures. Specific examples of such components may be found in the current literature, e.g., in Fenaroli's Handbook of Flavour Ingredients, 1975, CRC Press; Synthetic Food Adjuncts, 1947 by M. B. Jacobs, edited by Van Nostrand; or Perfume and Flavour Chemicals by S. Arctander 1969, Montclair, N.J. (USA).

It is commonplace for a plurality of perfume components to be present in a formulation. In the compositions of the present invention it is envisaged that there will be four or more, preferably five or more, more preferably six or more or even seven or more different perfume components.

In perfume mixtures preferably 15 to 25 wt. % are top notes. Top notes are defined by Poucher (Journal of the Society of Cosmetic Chemists 6 (2): 80 [1955]). Preferred top-notes are selected from citrus oils, linalool, linalyl acetate, lavender, dihydromyrcenol, rose oxide and cis-3-hexanol.

The International Fragrance Association has published a list of fragrance ingredients (perfumes) in 2011. (http://www.ifraorg.org/en-us/ingredients #.U7Z4hPldWzk) The Research Institute for Fragrance Materials provides a database of perfumes (fragrances) with safety information.

Perfume top note may be used to cue the whiteness and brightness benefit of the invention. Some or all of the perfume may be encapsulated, typical perfume components which it is advantageous to encapsulate, include those with a relatively low boiling point, preferably those with a boiling point of less than 300, preferably 100-250 Celsius. It is also advantageous to encapsulate perfume components which have a low CLog P (i.e. those which will have a greater tendency to be partitioned into water), preferably with a CLog P of less than 3.0. These materials, of relatively low boiling point and relatively low CLog P have been called the “delayed blooming” perfume ingredients and include one or more of the following materials: allyl caproate, amyl acetate, amyl propionate, anisic aldehyde, anisole, benzaldehyde, benzyl acetate, benzyl acetone, benzyl alcohol, benzyl formate, benzyl iso valerate, benzyl propionate, beta gamma hexenol, camphor gum, laevo-carvone, d-carvone, cinnamic alcohol, cinamyl formate, cis-jasmone, cis-3-hexenyl acetate, cuminic alcohol, cyclal c, dimethyl benzyl carbinol, dimethyl benzyl carbinol acetate, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl acetate, flor acetate (tricyclo decenyl acetate), frutene (tricyclco decenyl propionate), geraniol, hexenol, hexenyl acetate, hexyl acetate, hexyl formate, hydratropic alcohol, hydroxycitronellal, indone, isoamyl alcohol, iso menthone, isopulegyl acetate, isoquinolone, ligustral, linalool, linalool oxide, linalyl formate, menthone, menthyl acetphenone, methyl amyl ketone, methyl anthranilate, methyl benzoate, methyl benyl acetate, methyl eugenol, methyl heptenone, methyl heptine carbonate, methyl heptyl ketone, methyl hexyl ketone, methyl phenyl carbinyl acetate, methyl salicylate, methyl-n-methyl anthranilate, nerol, octalactone, octyl alcohol, p-cresol, p-cresol methyl ether, p-methoxy acetophenone, p-methyl acetophenone, phenoxy ethanol, phenyl acetaldehyde, phenyl ethyl acetate, phenyl ethyl alcohol, phenyl ethyl dimethyl carbinol, prenyl acetate, propyl bornate, pulegone, rose oxide, safrole, 4-terpinenol, alpha-terpinenol, and/or viridine. It is commonplace for a plurality of perfume components to be present in a formulation. In the compositions of the present invention it is envisaged that there will be four or more, preferably five or more, more preferably six or more or even seven or more different perfume components from the list given of delayed blooming perfumes given above present in the perfume.

Another group of perfumes with which the present invention can be applied are the so-called ‘aromatherapy’ materials. These include many components also used in perfumery, including components of essential oils such as Clary Sage, Eucalyptus, Geranium, Lavender, Mace Extract, Neroli, Nutmeg, Spearmint, Sweet Violet Leaf and Valerian.

It is preferred that the laundry treatment composition does not contain a peroxygen bleach, e.g., sodium percarbonate, sodium perborate, and peracid.

### Polymers

The composition may comprise one or more further polymers. Examples are carboxymethylcellulose, poly (ethylene glycol), poly(vinyl alcohol), polycarboxylates such as polyacrylates, maleic/acrylic acid copolymers and lauryl methacrylate/acrylic acid copolymers.

Where alkyl groups are sufficiently long to form branched or cyclic chains, the alkyl groups encompass branched, cyclic and linear alkyl chains. The alkyl groups are preferably linear or branched, most preferably linear.

### Adjunct Ingredients

The detergent compositions optionally include one or more laundry adjunct ingredients.

To prevent oxidation of the formulation an anti-oxidant may be present in the formulation.

The term “adjunct ingredient” includes: perfumes, dispersing agents, stabilizers, pH control agents, metal ion control agents, colorants, brighteners, dyes, odour control agent, pro-perfumes, cyclodextrin, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mould control agents, mildew control agents, antiviral agents, antimicrobials, drying agents, stain resistance agents, soil release agents, malodour control agents, fabric refreshing agents, chlorine bleach odour control agents, dye fixatives, dye transfer inhibitors, shading dyes, colour maintenance agents, colour restoration, rejuvenation agents, anti-fading agents, whiteness enhancers, anti-abrasion agents, wear resistance agents, fabric integrity agents, anti-wear agents, and rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, and combinations thereof. If present, such adjuncts can be used at a level of from 0.1% to 5% by weight of the composition

The invention will be further described with the following non-limiting examples.

### EXAMPLES

### Materials

Current commercial AES (Sodium alkyl ether sulfate) a mixture of C12/C14 alkyl with an average EO of ˜3, the alkyl chain is generally palm kernel oil/coconut oil derived-comparative material.

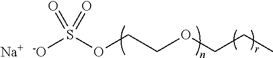

Where r is a mixture of 10 and 12 in an approximate ratio of 3:1.

Narrow range AES (Sodium alkyl ether sulfate) C12-C14 alkyl with an average EO of ˜3-according to the invention.

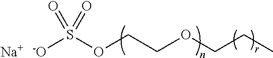

Where r is 12.

The narrow range alkyl ethyl sulfate material according to the invention can be prepared as follows:

A calcium catalyst was prepared according to EP1747183, with the following composition: n-Butanol 73.5 wt. %, calcium hydroxide 15.2 wt. %, 2-ethylhexanoic acid, and 3.5 wt. %, conc. sulfuric acid 7.8 wt. %.

To prepare the catalyst, a three-neck round bottom flask is equipped with a magnetic stir bar, a glass stopper, a Dean-Stark trap filled with n-butanol, a condenser topped with a calcium chloride drying tube, and is placed in an oil bath. The n-butanol is charged to the flask and, stirring is initiated. The calcium hydroxide is slowly added, and allowed to stir for 15 minutes. A carboxylic acid (such as 2-ethylhexanoic acid) is then added to the mixture via syringe. The flask containing the mixture is then heated to above 120 degrees centigrade at atmospheric pressure. The stirring suspension is allowed to reflux for up to about 8 hours. Under these conditions, water and the dispersing medium will be removed during the process, but the dispersing medium is recycled into the reaction vessel. After cooling to room temperature, the stir bar is removed, and an overhead stirrer is added. The Dean-Stark trap, condenser, drying tube, oil bath, and stoppers are removed. A source of nitrogen, thermometer, water bath, and pressure equalizing dropping funnel are added. The pressure equalizing dropping funnel is charged with an inorganic acid (such as sulfuric acid), and the acid is added over the course of about 3 hours. The internal temperature is maintained at or below about 25 degrees centigrade by the use of a water bath and ice. After the acid is added completely, the suspension is allowed to stir for an additional 30-60 minutes at a temperature of about 25° C.

This catalyst was used to produce narrow range ethoxylates. 915 g of a C14 alcohol (C14=100 wt. %) was charged into a 2 gallon stainless steel autoclave equipped with an overhead stirrer, internal steam heating, water cooling, and thermocouple. The C14 alcohol was vacuum dried at 90° C., then 2.1 g of catalyst was added and vacuum stripped at 90° C. until all the solvent was removed (˜5 minutes). The reactor was heated to 140° C. and ethylene oxide slowly added. After an induction period a small exothermic reaction is observed on which the addition of ethylene oxide is continued at a pressure of 2 bar, until 3 moles of ethylene oxide in total had been consumed. Temperature was controlled using water cooling and allowed to reach 180° C. When a mole ratio of 3:1 ethylene oxide to C14 alcohol had reacted to form alcohol ethoxylate the temperature was lowered to 90° C. and the product vacuumed stripped for 3 hours.

The ethoxylation procedure can be alternatively repeated using a (C₁₁H₂₃COO) 2Ba described in Ind. Eng. Chem. Res. 1992, 31, 2419-2421 and a barium oxide/sulfuric acid catalyst as described in WO2012028435 (Kolb).

The ethoxylated alcohol was then sulfated as described earlier to produce an AES material according to the invention.

### Example 1 Comparing the Ethoxylation Distributions of Current Commercial AES Material and AES Material According to the Invention

The ethoxylation profile of the ethoxylated material of the two surfactants was measured by Time of Flight (ToF) Mass Spectrometry. The conditions were as follows:

Samples are approximately 5 ppm (as supplied) made with Methanol containing 10 mM Ammonium Formate.
Samples were applied to the Mass Spec using a syringe pump set at 10 ul/min.
Mass Spec was a Waters Xevo G2-XS Accurate Mass Quadrupole Time of Flight Mass Spectrometer (No mass correction).
Electrospray negative.

The settings for the mass spectrometry were as follows:
Polarity ES-
Analyser Sensitivity Mode
Capillary (kV) 1.0000
Sampling Cone 30.0000
Source Temperature (° C.) 100
Source Offset 80° C.
Desolvation Temperature (° C.) 500
Cone Gas Flow (L/Hr) 10.0
Desolvation Gas Flow (L/Hr) 600.0

The results for the different ethoxylation (EO) materials in each sample were measured and normalized to 100% and shown in table 1. This allows for comparison of each sample as to the wt. % level of each EO level present compared to the total wt. % level of ethoxylated material.

TABLE 1
comparing wt. % of different EO materials in each sample

| EO | Commercial C12/C14 AES (SLES) | C14 Narrow range EO |
|---|---|---|
| 1 | 29.7 | 18.1 |
| 2 | 25.6 | 19.8 |
| 3 | 17.2 | 23.6 |
| 4 | 11.0 | 17.7 |
| 5 | 7.0 | 10.8 |
| 6 | 4.0 | 6.1 |
| 7 | 2.6 | 2.7 |
| 8+ | 2.9 | 1.2 |

It is apparent that the commercial sample has an ethoxylation profile that is maximal for 1EO and drops off for each ascending EO degree. The material according to the invention has an ethoxylation profile that is lower in levels of 1EO and 2EO but has more 3EO and 4EO. It can be considered to be ‘peaked’ in the levels of 3EO and 4EO in comparison to the commercial material.

### Example 2 Comparison of Foam Volumes for Commercial SLES 3EO and the Alkyl Ethoxylated Sulfate Surfactant According to the Invention

An assessment of the relative foamability of the current commercial AES (a) and the alkyl ethoxylated sulfate surfactant according to the invention [denoted as NR AES (b)] was made using a simulated handwash assessment. 2 litres of water 6° F.H water was added to a 10 litre bucket. The material of interest was dissolved in the water at a concentration of 0.5 g/L. In the first experiment the solution was agitated for 10 seconds by hand and the volume of foam in the bucket recorded after standing for 30 seconds. In the second experiment the solution was agitated for 30 seconds by hand and the volume of foam in the bucket recorded after standing for 30 seconds.

The results are shown in table 2:

TABLE 2
showing the comparison in resulting foam volume between
the commercial AES and the alkyl ethoxylated sulfate
surfactant according to the invention

| | Foam volume after | Foam volume after |
|---|---|---|
| | agitating for 10 | agitating for 30 |
| Material | seconds (litres) | seconds (litres) |
| Sodium C12-14 3EO Alkyl | 1.308 | 1.806 |
| Ether Sulphate (commercial | | |
| AES) (a) | | |
| Sodium C14 3EO Alkyl Ether | 2.439 | 3.346 |
| Sulphate (NR AES) (b) | | |

After agitating for 10 seconds the NR AES (b) gave an increase in foam volume of 86% compared to the commercial material.

After agitating for 30 seconds the NR AES (b) gave an increase in foam volume of 85% compared to the commercial material.

The weight efficiency of the two materials can be expressed as the volume of foam generated (litres) per grammes of material per litre. The results are shown in table 3.

TABLE 3
showing the comparison of weight efficiency of foam generation
between the commercial AES and the alkyl ethoxylated
sulfate surfactant according to the invention

| | Weight efficiency | Weight efficiency |
|---|---|---|
| | of foam generation | of foam generation |
| | after agitating for | after agitating for |
| Material | 10 seconds (L/g) | 30 seconds (L/g) |
| Sodium C12-14 3EO Alkyl | 2.616 | 3.612 |
| Ether Sulphate (commercial | | |
| AES) (a) | | |
| Sodium C14 3EO Alkyl Ether | 4.878 | 6.692 |
| Sulphate (NR AES) (b) | | |

This data shows that the narrow range alkyl ether sulphate materials according to the invention generate significantly higher foaming in comparison to the commercial material. It also shows that less material of the narrow range alkyl ether sulphate materials according to the invention is needed to generate similar foam levels in comparison to the commercial material.

1. A detergent composition comprising: from 0.5 to 50 wt. % of a C12-C14 alkyl ethoxylated sulfate surfactant, wherein at least 70 wt. % of the surfactant comprises a C14 alkyl group, and at most 10 wt. % of a C15 alkyl groups or higher;
wherein an average degree of ethoxylation (EO) is from 2.5 to 3.5; and
wherein, with reference to the wt. % of a total ethoxylated portion of the surfactant, a 1EO level is from 12 to 23 wt. %, a 2EO level is from 15 to 24 wt. %, a 3EO level is from 20 to 35 wt. %, and a 4EO level is from 12 to 25 wt. %.

2. The detergent composition according to claim 1, wherein at least 75 wt. % of the surfactant comprises.

3. The detergent composition according to claim 1, wherein the composition comprises of the surfactant.

4. The detergent composition according to claim 1, wherein the average degree of ethoxylation (EO) is from 2.7 to 3.3.

5. The detergent composition according to claim 1, wherein with reference to the wt. % of the total ethoxylated portion of the surfactant, the 1EO level is from 13 to 22 wt. %.

6. The detergent composition according to claim 1, wherein with reference to the wt. % of the total ethoxylated portion of the surfactant, the 2EO level is from 16 to 23 wt. %.

7. The detergent composition according to claim 1, wherein with reference to the wt. % of the total ethoxylated portion of the surfactant, the 3EO level is from 20 to 30 wt. %.

8. The detergent composition according to claim 1, wherein with reference to the wt. % of the total ethoxylated portion of the surfactant, the 4EO level is from 13 to 24 wt. %.

9. The detergent composition according to claim 1, further comprising from 1 to 40 wt. % of one or more other surfactants selected from anionic surfactants, nonionic surfactants, cationic surfactants and amphoteric surfactants.

10. The detergent composition according to claim 1, wherein the composition comprises from 0.5 to 15 wt. % of cleaning boosters selected from antiredeposition polymers, soil release polymers, alkoxylated polycarboxylic acid esters and mixtures thereof.

11. The detergent composition according to claim 10, wherein the antiredeposition polymers are alkoxylated polyamines.

12. The detergent composition according to claim 1, wherein the composition is a composition selected from powder detergent compositions, liquid detergent compositions, and gel detergent compositions.

13.-15. (canceled)

16. The detergent composition according to claim 1, wherein the composition comprises from 2 to 25 wt. % of the surfactant.

17. The detergent composition according to claim 1, wherein with reference to the wt. % of the total ethoxylated portion of the surfactant, the 1EO level is from 15 to 20 wt. %.

18. The detergent composition according to claim 1, wherein with reference to the wt. % of the total ethoxylated portion of the surfactant, the 2EO level is from 18 to 22 wt. %.

19. The detergent composition according to claim 1, wherein with reference to the wt. % of the total ethoxylated portion of the surfactant, the 3EO level is from 22 to 26 wt. %.

20. The detergent composition according to claim 1, wherein with reference to the wt. % of the total ethoxylated portion of the surfactant, the 4EO level is from 15 to 21 wt. %.

21. The detergent composition according to claim 10, wherein the soil release polymer is a polyester soil release polymer.

22. The detergent composition according to claim 1, wherein at least 95 wt. % of the surfactant comprises a C14 alkyl group.

23. A detergent composition comprising:
a. from 2 to 25 wt. % of a C12-C14 alkyl ethoxylated sulfate surfactant, wherein at least 50 wt. % of the surfactant comprises a C14 alkyl group, and at most 10 wt. % of a C15 alkyl groups or higher; and
b. from 0.5 to 15 wt. % of cleaning boosters selected from antiredeposition polymers, soil release polymers, and combinations thereof,
wherein an average degree of ethoxylation (EO) is from 2.5 to 3.5; and
wherein, with reference to the wt. % of a total ethoxylated portion of the surfactant, a 1EO level is from 10 to 25 wt. %, a 2EO level is from 15 to 24 wt. %, a 3EO level is from 20 to 35 wt. %, and a 4EO level is from 12 to 25 wt. %.
